(19) United States
(12) Patent Application Publication
(10) Pub. No.: US 2016/0121590 A1
(43) Pub. Date: May 5, 2016

(54) METHOD FOR ADHESIVE BONDING BY MEANS OF HEAT-ACTIVATABLE ADHESIVE COMPOUNDS

(71) Applicant: TESA SE, Norderstedt (DE)

(72) Inventors: Kim SULKAKOSKI, Kiiminki (FI); Frank HANNEMANN, Hamburg (DE); Alexander FISCHER, Hamburg (DE)

(73) Assignee: Tesa SE, Norderstedt (DE)

(21) Appl. No.: 14/895,951

(22) PCT Filed: May 26, 2014
(86) PCT No.: PCT/EP2014/060822

§ 371 Date: Dec. 4, 2015

(30) Foreign Application Priority Data
Jun. 6, 2013 (DE) 10 2013 210 531.2
Mar. 26, 2014 (DE) 10 2014 205 581.4

(51) Int. Cl. B32B 37/12; B32B 37/10; B32B 38/00

(52) U.S. Cl. CPC B32B 37/12; B32B 38/0008; B32B 37/10; B32B 2457/20; B32B 2457/208; B32B 2551/00

(57) ABSTRACT

A method for adhesively bonding two substrates using an adhesive film that bonds adhesively by activation with heat, wherein the adhesive film is not adhesive at room temperature, in a first step the adhesive film is laminated in a heated state onto the first of the substrates to be adhesively bonded, after the lamination, the side of the adhesive film that is not in contact with the first substrate to be adhesively bonded is initially exposed in order to be able to be brought into contact with the second substrate to be adhesively bonded, the adhesive film is activated by irradiating with electromagnetic radiation in the near infrared range (NIR), by heating to a temperature T_{K} above the lowest activation temperature T_{A,u}, and the adhesive bonding with the second substrate to be adhesively bonded is brought about by means of the activation by the NIR radiation.

This application is a 371 of International Patent Application No. PCT/EP2014/060822, filed May 26, 2014, which claims foreign priority benefit under 35 U.S.C. § 119 of the German Patent Application No. 10 2013 210 531.2, filed Jun. 6, 2013, and German Patent Application No. 10 2014 205 581.4, filed Mar. 26, 2014, the contents of which are incorporated herein by reference. The invention relates to a method for adhesively bonding two substrates by means of a heat-activatedly bondable adhesive film, and also to the application of this method to the adhesive bonding of components of electronic devices.

Within adhesive technology, the requirements imposed on very stable, durable adhesive bonds are increasing. Heat-activatedly bondable systems, these being systems which develop the bond strength required for adhesive bonding only under hot conditions, after an activation temperature or activation-temperature range has been exceeded, frequently display distinct advantages over adhesives which are pressure-sensitive at room temperature (referred to generally as self-adhesives or pressure-sensitive adhesives—PSAs). The bonds brought about by means of heat-activatable systems generally have higher bond strengths and are more stable.

Heat-activatable adhesives can be differentiated fundamentally into two categories: thermoplastic heat-activatable adhesives, and reactive heat-activatable adhesives.

### a) Thermoplastic Heat-Activatable Adhesives

This adhesive is activated by heat, becoming self-adhesive. The factor responsible for this is an appropriately high glass transition temperature on the part of the adhesive, and so the activation temperature for achieving sufficient tack—generally several tens to a hundred degrees Celsius—is situated above room temperature. An adhesive effect occurs even before the adhesive has set, owing to the self-adhesive properties which develop under the hot conditions. After the adherends have been assembled, the thermoplastic heat-activatable adhesive sets physically on cooling with solidification (use of suitable thermoplastic materials as adhesive; resulting generally in reversible bonding), and optionally chemically as well (use of suitable thermoplastically reactive materials as adhesive; resulting generally in irreversible bonding), and so the adhesive effect is retained in the cooled state, where it has formed the actual bond strengths.

The greater the extent to which heat, pressure and/or time is expended for the bonding, the stronger, generally, the connection between the two materials to be bonded. By this means it is possible regularly to realize maximum bonding strengths under technically simple processing conditions.

Thermoplastics are understood to be those compounds as defined in Römpp (online version; 2008 edition, document code RD-20-01271).

Thermoplastic heat-activatable adhesives are understood for the purposes of this specification to be adhesives as described above.

### b) Reactive Heat-Activatable Adhesives (Hot-Crosslinking Adhesives)

This rubric covers polymer systems of the kind having functional groups such that on supply of heat, a chemical reaction occurs, with the adhesive undergoing chemical setting and thus bringing forth the adhesive effect. Reactive heat-activatable adhesives generally do not become self-adhesive on supply of heat, and so the adhesive effect ensues only after setting has taken place. In many cases, reactive heat-activatable adhesives are not thermoplastic, but are instead realized through an elastomer/reactive resin system (compare, however, the heat-activatable sheets by means of thermoplastically reactive materials; see above). The glass transition temperature is not significant for the functionality of reactive systems.

Reactive heat-activatable adhesives, including hot-crosslinking adhesives, are understood in the context of this specification to be adhesives as described above.

However, heat-activatedly bondable systems also possess a number of disadvantages over self-adhesives: Accordingly, the bonding procedure is technically more complicated. Owing to the absence of bond strengths at room temperature, the adhesive film used must first be prelaminated while hot onto a material having good thermal conduction. Typically for this purpose temperatures around 100° C. are employed. The liner which is generally still present on the free side of the adhesive is removed from the prelaminated assembly, and the second substrate to be bonded is applied. Bonding proper then takes place with application of high temperatures—temperatures in the range of, for example, 150° C.-200° C. are customary—and also with application of pressure - customary pressures during the bonding operation are in the region of 10 bar.

During this operation, the ultimate strength of the bond to both substrates to be bonded is brought about. As a result of this process, not all materials can be bonded by means of heat-activatedly bondable adhesive films. Difficulties arise in particular when bonding a large number of plastics.

It is frequently difficult, moreover, to produce dimensionally precise adhesive assemblies, that the activation of the bond by means of heat and pressure takes place in one step, customarily in a hot press. Positioning of the second substrate to be bonded therefore takes place simultaneously with ultimate bonding to the final strength, meaning that it is not possible to correct the positioning. Particularly in the case of products where a very precise dimensional design is an issue, this leads to relatively high reject rates in production.

Particularly in the production of electronic devices, more particularly portable devices, temperature-sensitive materials are frequently employed. Virtually all devices in modern consumer electronics, for example, have visual display systems in order to display the operating status of the device, or other information. Where the events to be displayed are relatively complex, display is frequently performed using display modules based on liquid crystals (LCDs) or on organic light-emitting diodes (OLEDs). Displays of this kind are employed, for instance, with digital cameras, portable ultrasmall computers, and cell phones. In order to protect the display modules from any damage caused by external mechanical events, such as impacts, for example, display systems of these kinds customarily have transparent protective windows, which cover the outside of the display modules and so reduce the risk of the module being directly exposed. Protection of this kind is likewise necessary in nonelectronic visual display systems, such as for mechanical displays such as clocks or fill level displays on storage vessels, for example. Protective windows employed are customarily polymer panes (made, for example, of polycarbonate (PC), polymethyl methacrylate (PMMA)) or panes of glass, with each of the two systems having its pros and cons, and the selection therefore being made according to the specific application. The fastening of protective display windows or optical lenses in the housing of electronic devices, which consists customarily of plastic or metal, is nowadays accomplished primarily by means of double-sided adhesive tapes. It was hitherto impossible to attain the high bonding strength of heat-activatable adhesive systems, since in large part the materials used are themselves very temperature-sensitive, a factor which can lead, for example, to deformation of the components, and/or since the adhesive bonding of different materials with one another under hot conditions results in varying expansion of the materials used on account of their in part very different coefficients of thermal expansion, with the result that deformations, warping effects or even cracks may occur after the cooling of the components adhesively bonded with one another. However, since the areas of such components that are available for adhesive bonding are becoming increasingly smaller for such devices, the requirements imposed on the bonding itself are becoming ever higher, causing self-adhesives to reach their limits here. It is an object of the invention to specify a method for adhesively bonding two substrates, of which at least one is not thermally conductive, using non-pressure-sensitively adhesive, heat-activatedly bondable adhesive films, where the method is nevertheless not to be confined to the bonding of such substrates. The method ought desirably in principle to afford the possibility of being able to operate at moderate temperatures, in other words to avoid extreme heating of the substrates to be bonded.

The object has been achieved by application of a method wherein a non-pressure-sensitively adhesive, heat-activatable adhesive sheet is first prelaminated onto a substrate to be bonded, and in a second step the bond is brought about by irradiation with near-infrared radiation.

The invention relates accordingly to a method for adhesively bonding two substrates by means of a heat-activatedly bondable adhesive film, the adhesive film not being pressure-sensitively adhesive at room temperature. In a first step, the adhesive film, in the heated state, is laminated onto the first of the substrates to be bonded. Following lamination, the side of the adhesive film that is not in contact with the first substrate to be bonded lies initially open, in order to be able to be contacted with the second substrate to be bonded. If at the lamination stage the side of the adhesive film not in contact with the first substrate to be bonded is lined with a liner—as is customarily the case—, that liner is removed so that the adhesive film lies open.

In a second step, the adhesive film is activated by irradiation with electromagnetic radiation in the near-infrared range (NIR), by heating to a temperature T_{K} at least above the lowest activation temperature T_{A,u}, preferably above the highest activation temperature T_{A,o}. By means of the activation by the NIR radiation, bonding to the second substrate to be bonded is brought about.

The setting of thermoplastics is associated with their melting and resolidification. This process can be detected as enthalpy change by means of dynamic scanning calorimetry (DSC). Activation temperatures of thermoplastic adhesives are determined via DSC measurement in a dynamic method according to DIN 53765:1994-03; see, in particular, sections 2.2.2, 7.2 and 8.2. The figures for the activation temperature T_{A} in this specification relate to the extrapolated onset temperature T_{SP}^{E} according to DIN 53765:1994-03 in the second heating operation, unless something different is stated in the individual case.

Given that the process of setting in reactive heat-activatable adhesives is a chemical crosslinking reaction, the process can be detected using dynamic scanning calorimetry (DSC) by way of the associated enthalpy change. Determination of activation temperatures of hot-crosslinking adhesives is accomplished via DSC measurement in a dynamic method in accordance with DIN 53765:1994-03 - see, in particular, sections 2.2.5, 7.3 and 8.4. The first step is conditioning in a heating operation to 100° C. (in the case of systems with activation temperatures below 120° C., up to about 20° C. below the lowest activation temperature), followed by cooling to −140° C., and the second heating operation is run to above the activation range. The figures for activation temperature T_{A} in this specification relate to the extrapolated onset temperature T_{RO}^{E} in accordance with DIN 53765:1994-03 in the second heating operation, unless anything different is said in the individual case.

Where two or more setting operations occur in the heat-activatably bondable adhesives on heating, because, for instance, two or more different crosslinking reactions take place (this may be the case, for example, for reactive, heat-activatable adhesives which include two or more different reactive resins and/or two or more different crosslinkers), then the system generally has a corresponding number of activation temperatures. In the text below, the activation temperature of the setting operation that occurs first during heating will be referred to as the lowest activation temperature T_{A,u}, and the activation temperature of the setting operation that occurs last during heating will be referred to as the highest activation temperature T_{A,o}. If there is only one setting operation, then lowest activation temperature T_{A,u} and highest activation temperature T_{A,o} are identical (in that case T_{A}=T_{A,u}=T_{A,o}).

Pressure-sensitively adhesive substances are defined by Römpp as those viscoelastic adhesives (Rompp Online 2013, document code RD-08-00162) whose set, dry film at room temperature is permanently tacky and remains adhesive. Adhesion is accomplished by gentle applied pressure immediately on almost all substrates.

Regarded as not pressure-sensitively adhesive in the sense of this invention, accordingly, are those polymer compositions which at room temperature, after contacting with a surface of the same film, do not attach, in other words fall off immediately again as soon as they are exposed to gravity; in particular, they do not attach under an applied pressure of 1 bar which is maintained for a duration of 3 seconds.

Regarded as not pressure-sensitively adhesive in the sense of the present specification, in particular, are those adhesive films which are not measurable according to DIN EN 1939:2003-12, paragraph 5 (method 1), since they do not attach.

Since the heat-activatedly bondable adhesive film at room temperature is not pressure-sensitively adhesive, it is difficult to position the two substrates to be bonded and the adhesive film in a dimensionally stable manner such that activation produces the adhesive assembly in the desired design. First of all, therefore, a preliminary assembly is produced from one of the two substrates (the first substrate) and the adhesive film, by placing a free surface of the adhesive film onto the first substrate and carrying out lamination. If the adhesive film is lined on both sides with a liner, the liner is removed on one side of the adhesive film, in order to generate a free surface.

The adhesive film is laminated to the first substrate under hot conditions, very advantageously at a temperature or—in the case of non-constant laminating temperature—in a temperature range below the lowest activation temperature T_{A,u} of the adhesive film. Here, the viscosity of the adhesive film already falls to an extent such that there is a certain flow of the adhesive film onto the first substrate and therefore an attachment, which is sufficiently large to accomplish the assembly. Lamination takes place advantageously at temperatures in the range from 80° C. to about 120° C., advantageously in the range from 90° C. to 110° C., such as, for instance, at 100° C. The adhesive film prior to lamination is advantageously already preheated, more particularly to a temperature below the laminating temperature, or to the laminating temperature. This preheating may be brought about likewise by means of electromagnetic radiation in the near-infrared (NIR) range and/or using other heat sources.

During lamination, pressure is preferably exerted on the assembly to be produced. For the lamination it is possible with advantage to use a hot roll laminator or a hot press.

Since the heat—in a hot roll laminator, for example—during the laminating process can be introduced into the assembly from the adhesive film side, the first substrate, for successful lamination, need not necessarily be thermally conductive. However, the first substrate may also be heated prior to lamination, again, for example, by NIR irradiation or other heat sources.

The lamination produces an assembly of first substrate and adhesive film, although generally the bond strength between first substrate and adhesive film are still well below the bond strengths achieved ultimately—after activation.

As heat-activatably bondable adhesive films it is possible to use films of thermoplastically heat-activatable adhesives and films of reactively activatable, i.e. hot-crosslinking, adhesives. In accordance with the invention the adhesive film is activated by irradiation with electromagnetic radiation in the near-infrared range (NIR). Additionally, optionally, there may be heating of the adhesive film by other heat sources, though this is not mandatory according to the invention.

For the activation, the adhesive film can be activated prior to contacting with the second substrate. If the (free) adhesive film surface, not in contact with the first substrate, is lined in turn with a liner, in the assembly produced during lamination, this liner ought advantageously to be removed prior to NIR irradiation. In principle, however, it is also possible to perform the NIR irradiation through the liner, if said liner is NIR-transparent, and to remove the liner afterward.

It may be advantageous to heat the second substrate in turn before its contacting with the adhesive film, particularly to the temperature of the activated adhesive film. This affords the advantage that on contacting, the second substrate is not cold and does not remove the heat from the adhesive film. Heating may be accomplished advantageously by exposing the second substrate as well, before it is contacted with the adhesive film, to the influence of the NIR radiation, advantageously at the same time as the adhesive film, as for example in the same NIR irradiation unit. Alternatively, the second substrate may be heated also with other heat sources, which may also be used additionally to the NIR source.

The irradiation prior to contacting with the second substrate is especially suitable for adhesive films which remain tacky for a certain time after activation by NIR irradiation and the subsequent ending of radiation exposure, remaining tacky for at least three seconds, for example. Very advantageous systems are those which remain adhesive for at least 5 seconds, as for example for a period from 5 to 10 seconds.

In an alternative procedure, the exposed side of the adhesive film of the assembly produced during lamination—optionally after removal of a liner still present on this side of the adhesive film—can first be contacted with the second substrate and, after the contacting of the adhesive film with the second substrate, the irradiation may take place through this second substrate. This procedure is especially suitable if the second substrate is transparent, or at least partly transparent, to NIR radiation.

With both of the aforementioned procedures—irradiation before and after contacting of the free side of the adhesive film with the second substrate, respectively—the NIR irradiation may also take place from the side of the first substrate, if the first substrate is transparent to NIR radiation.

The activation of the adhesive film takes place advantageously in a wavelength range between 0.8 and 1.2 μm.

As a result of the NIR irradiation, the adhesive film is heated preferably to a temperature of at least 120° C., preferably of 150° C. The respective temperature may advantageously be selected in dependence on the adhesive film used and on its activation temperature or temperatures. The maximum utilizable temperature for the bonding operation is freely selectable in principle and is dependent only on the particular heat resistance of the adhesive film used and of the substrates to be bonded; customarily, temperatures of more than 300° C. ought to be avoided, and so in many cases a favorable temperature range for the activation of the adhesive film has emerged as being from 150° C. to 300° C.

The NIR irradiation affords the advantage that the heating is virtually instantaneous, customarily with heating times of a few seconds (frequently in the range from 2 to about 10 seconds). Heating is continued advantageously until the free surface that is to be contacted with the second substrate—or, in the case of already existing contact with the second substrate, the surface of the second substrate—has reached the desired temperature. This can be measured, for example, using a pyrometer (radiation thermometer).

A further advantage afforded by the NIR irradiation is that the heating can take place in accordance with time/temperature programs, something which may be useful, for example, in order to obtain more precise adhesive bonds or for the bonding of particularly sensitive substrates. Time/temperature programs of this kind may likewise be realized through the use of a pyrometer.

Following the contacting of the adhesive film with the second substrate, and the NIR irradiation (the NIR irradiation, as observed above, may take place before or after the contacting), the resultant assembly is very advantageously pressed, in order to improve the flow of the activated adhesive film, in particular, onto the second substrate, but also onto the first substrate, and so to optimize the bonding strength. For this purpose it is possible for example to utilize compressed-air presses or pneumatic presses. Pressure and pressing time may be adapted to the particular system.

A very preferred procedure is for the pressing operation to take place within the time, or at least to be commenced within the time, in which the adhesive film after the NIR radiation still has sufficiently good processability (having set to an appropriately sufficiently small extent). The pressing operation takes place advantageously within 10 s, preferably within 5 seconds, after the end of exposure to the NIR radiation.

Customary pressing pressures—without wishing to be confined by these details—are in the range of up to 10 bar, frequently up to 5 bar, up to 2 bar or up to 1 bar.

In contrast to hot presses used before now, the method of the invention affords the advantage of detaching the heating operation from the pressing operation, in other words of decoupling the exposure to heat and to pressure. As a result of this, there are better possibilities for the positionability of the components of the assembly that is to be produced relative to one another.

Heat-activatedly bondable adhesive films within the meaning of the present specification are understood to be films based on polymer systems which are not pressure-sensitively adhesive at room temperature but which, through the influence of heat, on reaching or after exceeding an activation temperature, can be activated in such a way that, during or after the heating, the polymer system sets physically or chemically—more particularly, films based on thermoplastically heat-activatable or reactively heat-activatable adhesives. The polymer system may have two or more activation temperatures, especially if there are two or more setting processes that can take place.

As heat-activatable adhesives suitable in accordance with the invention it is possible to use reactive heat-activatable adhesives and thermoplastic heat-activatable adhesives.

As reactive heat-activatable adhesives it is possible with preference to use one based on a mixture of at least one nitrile rubber S1 and a reactive component, more particularly a reactive resin.

The weight fraction of the nitrile rubber S1 is preferably between 25 and 70 wt %, more preferably between 30% and 60% of the overall composition of the reactive heat-activatable sheet.

The nitrile rubbers S1 preferably have an acrylonitrile fraction of 15% to 45%. A further criterion for the nitrile rubber S1 is the Mooney viscosity. Given the need to ensure a high flexibility at low temperatures, the Mooney viscosity ought preferably to be below 100 (Mooney ML 1+4 at 100° C.; conforming to DIN 53523). Commercial examples of nitrile rubbers of this kind are, e.g., Nipol™ N917 from Zeon Chemicals.

Reactive resins are understood in particular to be short-chain to medium-chain, oligomeric or polymeric compounds, more particularly having average molecular weights in the range up to 10 000 g/mol. Determinations of the average molecular weight MW and of the polydispersity PD are based on gel permeation chromatography (GPC) [eluent THF with 0.1 vol % trifluoroacetic acid; measuring temperature 25° C.; pre-column PSS-SDV, 5 μm, 103 Å (10⁻⁷ m), ID 8.0 mm×50 mm; separating columns PSS-SDV, 5 μm, 103 Å (10⁻⁷ m), 105 Å (10⁻⁵ m) and 106 A (10⁻⁴ m) each with ID 8.0 mm×300 mm; sample concentration 4 g/l; flow rate 1.0 ml per minute; measurement against PMMA standards].

The fraction of the reactive resins in the heat-activatable adhesive is preferably between 75 and 30 wt %. One very preferred group comprises epoxy resins. The weight-average molecular weight M_{w} of the epoxy resins varies from 100 g/mol up to a maximum of 10 000 g/mol for polymeric epoxy resins.

The epoxy resins comprise, for example, the reaction product of Bisphenol A and epichlorohydrin, epichlorohydrin, glycidyl ester, the reaction product of epichlorohydrin and p-aminophenol.

Preferred commercial examples are, e.g., Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071, HPT™ 1079, likewise from Shell Chemical.

Examples of commercial aliphatic epoxy resins are, e.g., vinylcyclohexane dioxides, such as ERL-4206, ERL-4221, ERL 4201, ERL-4289 or ERL-0400 from Union Carbide Corp.

Novolak resins which can be used are, for example, Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As reactive resins it is also possible, furthermore, to use melamine resins, such as Cymel™ 327 and 323 from Cytec, for example.

In a very preferred procedure, reactive resins used comprise phenolic resins. Outstandingly suitable are, for example, novolak resins, phenolic resole resins, or combinations of novolak resins and phenolic resins. Examples of commercially available phenolic resins to use are YP 50 from Toto Kasei, PKHC from Union Carbide Corp., and BKR 2620 from Showa Union Gosei Corp.

As reactive resins, moreover, it is also possible to use terpene phenolic resins, such as NIREZ™ 2019 from Arizona Chemical, for example.

As reactive resins it is also possible, moreover, to use polyisocyanates, such as Coronate™ L from Nippon Polyurethan Ind., Desmodur™ N3300 or Mondur™ 489 from Bayer, for example.

In order to accelerate the reaction between the two components, it is also possible, optionally, for crosslinkers and accelerators to be additized into the mixture.

Examples of suitable accelerators include imidazoles, available commercially as 2M7, 2E4MN, 2PZ-CN, 2PZ-CNS, P0505, LO7N from Shikoku Chem. Corp., or Curezol 2MZ from Air Products. Additionally suitable as crosslinkers are HMTA (hexamethylenetetramine) additives.

Amines, especially tertiary amines, may also be used, moreover, for acceleration.

In a further preferred embodiment, other additives are added to the blend, such as, for example, polyvinyl formal, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers, styrene-butadiene rubbers.

Polyvinyl butyrals are available as Butvar™ from Solutia, as Pioloform™ from Wacker, and as Mowital™ from Kuraray. Polyacrylate rubbers are available as Nipol AR™ from Zeon. Chloroprene rubbers are available as Baypren™ from Bayer. Ethylene-propylene-diene rubbers are available as Keltan™ from DSM, as Vistalon™ from Exxon Mobile, and as Buna EP™ from Bayer. Methyl-vinyl-silicone rubbers are available as Silastic™ from Dow Corning and as Silopren™ from GE Silicones. Fluorosilicone rubbers are available as Silastic™ from GE Silicones. Butyl rubbers are available as Esso Butyl™ from Exxon Mobile. Styrene-butadiene rubbers are available as Buna S™ from Bayer, and Europrene™ from Eni Chem, and as Polysar S™ from Bayer. Polyvinyl formals are available as Formvar™ from Ladd Research.

Heat-activatable adhesives of the invention which can be used in a further version comprise thermoplastic polymers, preferably having a softening temperature of greater than 85° C. and less than 150° C. The statement of softening points of polymeric compounds is made in relation to the ring & ball method, by corresponding application of the provisions of DIN EN 1427:2007 (analysis of the polymeric sample rather than bitumen, with the procedure otherwise retained; measurements in a glycerol bath).

Examples of suitable thermoplastics are polyesters and copolyesters, polyamides and copolyamides, thermoplastic polyurethanes, polyolefins, such as polyethylene (Hostalen®, Hostalen Polyethylen GmbH), polypropylene (Vestolen P®, DSM). It is also possible, furthermore, to use blends of different thermoplastics, and also to use two different thermoplastics (e.g. double-sided coating or different coating on either side of a nonwoven carrier web).

In one preferred form of presentation, the heat-activatable adhesives are used in layer form, in other words in the form of a heat-activatable adhesive sheet. Adhesive sheets of this kind may be present in one-layer form (known as adhesive transfer sheets) or may have a carrier, resulting in carrier-containing, single-sided or double-sided adhesive sheets.

With particular preference, one-, two- or three-layer heat-activatable adhesive sheets are used, and so the overall thickness of the adhesive sheet—depending on the surface roughness, curvature, or size of the substrates on which bonding is intended—is in the range from 25 to 750 μm, more preferably in the range from 30 to 250 μm. Adhesive sheets of this kind may be used, for example, outstandingly for the bonding of metal parts on plastics, of metals on metals, and, in particular, of plastics on plastics.

While with conventional bonds using heat-activatable films it is generally necessary for at least one of the substrates to have good thermal conductivity, the method of the invention allows even materials with poor thermal conductivity or none to be bonded effectively, reliably, and stably using films which are not pressure-sensitively adhesive at room temperature. However, the method of the invention may likewise be employed outstandingly for all materials already known for adhesive bonding by means of heat-activatable systems.

The method of the invention is especially advantageous for the adhesive bonding of two plastics to one another and also of a plastic to other materials, such as metals, glass, stone, wood, textiles, etc. The materials may also be present in surface-modified form, having been—for example—printed, coated, vapor-coated, anodized and/or etched.

Plastics frequently have heightened heat sensitivity and customarily, in general, poor thermal conductivity. It has emerged that heating by NIR is a very gentle method, without, for example, there being any warping or deformation of the plastics substrates, even if heating takes place to relatively high temperatures. Since there is no need for a thermally conductive substrate to transmit the heat to the adhesive film, it is also possible for two substrates with poor or no thermal conductivity to be bonded to one another outstandingly by the method of the invention. With the method of the invention, furthermore, heat-activatable adhesive systems having a very high impact strength can also be utilized for bonding under moderate conditions. Such systems improve the impact resistance (shock resistance) of the products manufactured.

The invention further provides a heat-activatedly bondable adhesive film which is not pressure-sensitively adhesive at room temperature but which is such that, by NIR irradiation, it can be heated to a temperature above its lowest, preferably above its highest, activation temperature, and which, after the end of radiation exposure, still remains adhesive for a certain time; more particularly, the adhesive films in question are those as described in this specification—including in connection with the method of the invention.

Since the method of the invention can be carried out under very gentle conditions, it is appropriate in particular for the bonding of thermally labile components of devices, in other words those components which under exposure to temperatures may be destroyed, damaged, deformed, or otherwise undesirably altered, or which for other reasons do not tolerate the effect of relatively high temperatures. The invention therefore further provides the application of the method of the invention to the adhesive bonding of components of optical, electronic, optoelectronic and/or precision-mechanical devices by means of a heat-activatedly bondable adhesive film. In this regard, all versions of the method of the invention stated as being advantageous apply accordingly.

It has been determined that even in the case of very small bond areas of a few square millimeters, and, indeed, in the case of those of less than one square millimeter, it has been possible to obtain outstanding strength properties and resistance properties even under such loads. In accordance with the invention, in particular, the assembly obtained is a permanent assembly, in other words an assembly which is to be durably stable for the period of use of the arrangement or of the device into which the assembly is integrated. Parting of the bond before the end of the lifetime of the arrangement or the device—in contrast to temporarily bonded components—is generally not intended but with great preference there is to be a possibility of reworkability—in other words, for example, an intended possibility of parting in the case of products manufactured erroneously.

Arrangements of optical, electronic and/or precision-mechanical devices are being used more and more frequently in commercial products, or are not far away from market introduction. Arrangements of these kinds include inorganic or organic electronic structures, examples being organic, organometallic, or polymeric semiconductors, or else combinations of these. Depending on the desired application, these arrangements and products are rigid or flexible in design, there being an increasing demand for flexible arrangements.

Examples of applications advantageous in accordance with the invention here might include electrophoretic or electrochromic constructions or displays, organic or polymeric light-emitting diodes (OLEDs or PLEDs) in readout and display apparatus, or as illumination, electroluminescent lamps, light-emitting electrochemical cells (LEECs), organic solar cells, preferably dye or polymer solar cells, inorganic solar cells, preferably thin-film solar cells, more particularly based on silicon, germanium, copper, indium and/or selenium, organic field-effect transistors, organic switching elements, organic optical amplifiers, organic laser diodes, organic or inorganic sensors, or else organically or inorganically based RFID transponders.

In view of the gentle conditions, the method of the invention is outstandingly suitable for the bonding of substrates—including, in particular, rigid substrates, which customarily are therefore also fragile—especially in the area of optical, electronic, optoelectronic and/or precision-mechanical devices. Such devices are customarily available in portable versions, in other words in a form intended to be able to be carried at all times by their owner, and in fact usually being generally carried as well.

In one preferred embodiment, rigid substrates are bonded permanently to one another. Rigid substrates in the sense of this specification are for example—in particular, sheetlike—substrates of glass, of metal, of ceramic, or of other materials, including surface-modified substrates such as, for example, printed, coated, vapor-coated, and anodized substrates, having an elasticity modulus (DIN EN ISO 527) of more than 10 GPa, preferably of more than 50 GPa, the aforementioned in particular with a thickness of at least 500 μm, but also sheetlike substrates made from plastics such as polyester (PE), polymethyl methacrylate (PMMA), polycarbonate (PC), of acrylonitrile-butadiene-styrene copolymers (ABS), or of other materials having an elasticity modulus of at least 1 GPa but not more than 10 GPa; the plastics substrates and substrates of materials having an elasticity modulus of at least 1 GPa but not more than 10 GPa, in particular with a thickness of at least 1 mm. Customarily the sheetlike substrates are also used with a greater thickness, for instance 2 mm or more.

As already mentioned at the outset, a problem which occurs particularly with rigid materials is that the heating of the components or of the assembly, or the cooling of the assembly after heat-activated bonding, may be accompanied by stresses, which may lead to instances of deformation, as for example a warping of the entire assembly, or deformations of individual components, or to cracks in the assembly. With heat-activated adhesive bonds, this problem occurs more in particular when different materials are bonded that have different coefficients of thermal expansion, because bonding takes place in the heated and therefore expanded state. Differences in the extent of expansion of the materials may occur, for example, even during heating, and/or the expansion of the materials is reversed to differing extents during cooling. The method of the invention, in contrast, takes place with moderate heating, and so the problems outlined do not occur here, or not to a substantial extent.

The substrates used are regarded in particular as being rigid when the product of thickness and elasticity modulus is at least 500 N/mm. Particular preference is given to using substrates whose product of thickness and elasticity modulus is at least 2500 N/mm, more preferably 5000 N/mm. The more rigid the substrates used, the less well that the substrate itself is able to absorb shock.

The adhesive is also suitable outstandingly, however, for the permanent bonding of flexible materials, especially in the production of flexible displays. Such displays are becoming more important.

In an advantageous way, the adhesive may be used for bonding windows or lenses into housings of precision-mechanical, optical and/or electronic devices (referred to as lens mounting). In this case at least one of the rigid or flexible substrates is transparent or translucent. The transparent or translucent substrate may be, for example, a window or an optical lens for protecting sensitive components disposed beneath it—examples of such components may include liquid crystal displays (LCDs), light-emitting diodes (LEDs) or organic light-emitting diodes (OLEDs) of displays, or alternatively printed circuits or other sensitive electronic components; a large part is played by this in connection, for example, with use for touch-sensitive displays—and/or in order to produce optical effects for the functioning of the device—for example, refraction, light bundling, light attenuation, light amplification, etc. In the bonding region, in other words over part of the area, generally in the edge region, such windows are frequently provided with a nontransparent coating, for instance a lacquer coating, known as “backprints”. Backprints are generally applied hidingly and customarily have layer thicknesses in the micrometer range. For bonding on the backprint surface as well, the method of the invention is outstandingly suitable, without damaging said surface.

Very advantageously, the transparent substrate, optionally provided over part of its area with a nontransparent backprint, is selected such that in the transparent range it exhibits a haze value of not more than 50%, preferably of not more than 10%, very preferably of not more than 5% (measured according to ASTM D 1003).

The second substrate is preferably likewise a component of a precision-mechanical, optical and/or electronic device. Consideration may be given here in particular to housings of such devices or to mounts for lenses or windows as described above.

In one preferred procedure, the transparent or translucent substrate, optionally provided over part of its area with a backprint, is a glass, polymethyl methacrylate and/or polycarbonate substrate.

The second substrate may consist in particular of plastics such as acrylonitrile-butadiene-styrene copolymers (ABS), polyamide, or polycarbonate, which in particular may also be glass fiber-reinforced; or may consist of metals, such as aluminum—including anodized aluminum—or magnesium, and metal alloys.

The substrate materials may be admixed with additives, such as dyes, light stabilizers, aging inhibitors, plasticizers, or the like, for example, if this is advantageous for the intended use; in the case of transparent or translucent materials, in particular, only to an extent such that it does not disrupt these optical properties, or disrupts them only to an acceptable extent.

Electronic, optical, optoelectronic, and precision-mechanical devices within the sense of this application are, in particular, devices as classified in class 9 of the International classification of goods and services for the registration of marks (Nizza classification), 10th edition (NCL(10-2013)), insofar as they are electronic, optical, or precision-mechanical devices, and also clocks and chronometric devices under class 14 (NCL(10-2013)), such as, in particular
scientific, marine, measurement, photographic, film, optical, weighing, measuring, signaling, monitoring, rescuing, and instruction apparatus and instruments;
apparatus and instruments for conducting, switching, converting, storing, regulating and monitoring electricity;
image recording, processing, transmission, and reproduction devices, such as televisions and the like
acoustic recording, processing, transmission, and reproduction devices, such as broadcasting devices and the like
computers, calculating instruments and data-processing devices, mathematical devices and instruments, computer accessories, office instruments—for example, printers, faxes, copiers, typewriters—, data-storage devices
telecommunications devices and multifunction devices with a telecommunications function, such as telephones and answering machines
chemical and physical measuring devices, control devices, and instruments, such as battery chargers, multimeters, lamps, and tachometers
nautical devices and instruments
optical devices and instruments
medical devices and instruments and those for sports people
clocks and chronometers
solar cell modules, such as electrochemical dye solar cells, organic solar cells, and thin-film cells
fire-extinguishing equipment.

Technical development is going increasingly in the direction of devices which are ever smaller and lighter in design, allowing them to be carried at all times by their owner, and in fact usually being generally carried. This is accomplished customarily by realization of low weights and/or suitable size of such devices. Such devices are also referred to as mobile or portable devices for the purposes of this specification. In this development trend, precision-mechanical and optical devices are increasingly being provided (also) with electronic components, thereby raising the possibilities for minimization. On account of the carrying of the mobile devices, they are subject to increased loads—in particular, to mechanical loads—as for instance by impact on edges, by being dropped, by contact with other hard objects in a bag, or else simply by the permanent motion involved in being carried per se. Mobile devices, however, are also subject to a greater extent to loads due to moisture exposure, temperature influences, and the like, than those “immobile” devices which are usually installed in interiors and which move little or not at all. The requirements imposed on reliable bonding, even when bonding areas are very small, are particularly high here. The invention accordingly refers with particular preference to mobile devices. Listed below are a number of portable devices, without wishing the representatives specifically identified in this list to impose any unnecessary restriction with regard to the subject matter of the invention.
cameras, digital cameras, film cameras, video cameras
small computers (portable computers, pocket computers, calculators), laptops, notebooks, netbooks, ultrabooks, tablet computers, handhelds, electronic appointment calendars and organizers (known as electronic organizers or personal digital assistants, PDAs, palmtops), modems
monitors, displays, screens, in particular touch-sensitive screens and devices with touch-sensitive screens (“touchscreen devices”, sensor screens)
reading devices for electronic books (e-books)
small televisions, pocket televisions, film player devices, video player devices
telephones, cordless telephones, cellphones, smartphones, two-way radios, hands-free devices, personal calling devices (pagers, beepers)
GPS devices, navigation devices
wristwatches, digital clocks.

With the method of the invention, success has been achieved in rendering a heat-activatable adhesive bond suitable for use as well for those materials where one or both of the materials is or are thermally labile, or where substantial thermal changes during the method would lead to problems.

### EXPERIMENTAL SECTION

### Production of the Adhesives for Investigation

### Reactive Heat-Activatable Adhesive

50 w t% Breon N41H8OGR (nitrile rubber) from Zeon, 36.8 wt % Durez 33040 phenolic novolak resin, 3.2% HMTA (Rohm and Haas), and 10 wt % of the 9610 LW phenolic resol resin from Bakelite were produced as a 30% strength solution in methyl ethyl ketone in a kneading apparatus. The duration of kneading was 20 h. The heat-activatable adhesive was subsequently coated out from solution onto a glassine release paper, and dried at 100° C. for 10 minutes. After drying, the coat thickness was 125 urn.

### Thermoplastic Heat-Activatable Adhesive

Grilltex™ 1442 E from EMS-Grilltech (copolyester-based thermoplastic polymer; polymer melting range according to manufacturer data: between 93° C. and 121° C.) was pressed to 150 μm in a hot press at 140° C. between two layers of siliconized glassine release paper.

### Sample Preparation

Circular diecuts having a diameter of 21 mm were punched out from the adhesive sheets under investigation, which had been lined in each case with a liner on both sides. The liner was subsequently removed in each case from one side of a diecut, and the diecut was laminated using a hot roll laminator accurately onto a circular sample disk whose diameter was likewise 21 mm. In this way, sample specimens with sample disks of glass, and those with sample disks of polycarbonate, were produced (see table).

Forming the second substrate was a square perforated plate consisting either of aluminum (Al), of polycarbonate (PC), or of glass fiber-reinforced polyamide (PA) (see table); side lengths in each case 40 mm, with a central round perforation (perforation diameter 9 mm) in the square plate.

For adhesive bonding, the liner on the side of the adhesive film not in contact with the sample disk in each sample specimen was removed, so that the adhesive film lay open. Then one of the following procedures for NIR irradiation was carried out.

### Bonding

### Procedure A

The circular test specimen was irradiated from the open adhesive film side, for the irradiation time specified in each case, in an NIR unit with NIR radiation (wavelength in the range from 0.8 to 1.2 μm). Immediately after the end of the irradiation, the circular test specimen was removed from the NIR unit and positioned immediately with the open adhesive film side on the perforated plate, which was at a temperature of 23° C. (room temperature), in such a way that the center of the circular sample specimen and the center of the perforation in the perforated plate lay one above the other. Using a compressed-air press, the assembly thus produced was pressed under a pressure of 5 bar for five seconds. Positioning of the circular sample specimen on the perforated plate, and pressing, were within a period of a maximum of 10 seconds after the end of NIR irradiation.

### Procedure B

The circular sample specimen was now irradiated from the open adhesive film side, for the irradiation time specified in each case, in an NIR unit with NIR radiation (wavelength in the range from 0.8 to 1.2 μm). In the same NIR unit, simultaneously, the perforated plate was subjected to NIR radiation and heated. Immediately after the end of the irradiation, the circular test specimen was removed from the NIR unit and positioned immediately with the open adhesive film side on the perforated plate, heated in the NIR unit, in such a way that the center of the circular sample specimen and the center of the perforation in the perforated plate lay one above the other. A compressed-air press was used to subject the assembly produced accordingly to pressing under a pressure of 5 bar for five seconds. Positioning of the circular sample specimen on the perforated plate, and pressing, were within a period of a maximum of 10 seconds after the end of NIR irradiation.

### Procedure C

Before NIR irradiation, the circular sample specimen, by the open adhesive film side, was positioned onto the perforated plate in such a way that the center of the circular sample specimen and the center of the perforation in the perforated plate lay one above the other. This assembly was irradiated from the side of the circular sample disk (in this case of glass)—through said disk—for the irradiation time indicated in each case, in an NIR unit with NIR radiation (wavelength in the range from 0.8 to 1.2 μm). A compressed-air press was used to subject the assembly thus bonded to pressing under a pressure of 5 bar for five seconds within a period of not more than 10 seconds after the end of NIR irradiation.

### Push-Out Test

The push-out test allows statements to be made about the bonding strength of a double-sidedly adhesive product in the direction of the line normal to the adhesive layer. For this purpose, pressure was applied to the circular test specimen perpendicularly, by means of a mandrel clamped in a tensile tester, through the perforation in the perforated plate, with a constant speed of 10 mm/min (in other words, parallel to the normal vector to the test specimen plane; centered centrally on the middle of the perforation) until the bond loosened to an extent such that a pressure drop of 50% was recorded. The pressure acting immediately prior to the drop in pressure is reported as maximum pressure Pₘₐₓ.

### Results

### Reactive Heat-Activatable Adhesive

| Procedure | Combination | Irradiation time [s] | Push out [N/mm²] |
|---|---|---|---|
| A | PC disk/PA frame | 6 | 1.47 |
| A | PC disk/PC frame | 6 | 1.36 |
| B | PC disk/PA frame | 6 | 2.96 |
| C | Glass disk/PA frame | 6 | 0.80 |
| C | Glass disk/PA frame | 8 | 4 |

### Thermoplastic Heat-Activatable Adhesive

| Procedure | Combination | Irradiation time [s] | Push out [N/mm²] |
|---|---|---|---|
| A | Glass disk/AI frame | 8 | 0.98 |
| A | Glass disk/PA frame | 8 | 4 |

Outstanding bonding strengths were achievable even on decoupling of irradiation from pressing operation. Through heating of the second substrate ahead of adhesive bonding, even higher bonding strengths are obtained. Irradiation through one of the substrates also leads to outstanding results. The bonding of plastics to plastics by means of heat-activatedly bondable adhesive sheets is excellent.

1. (canceled)

2. The method as claimed in claim 19, wherein the adhesive film is activated by irradiation with electromagnetic radiation in the near-infrared range (NIR) by heating to a temperature T_{K} above the highest activation temperature T_{A,o}.

3. The method as claimed in claim 19, wherein the activation is accomplished by NIR radiation in a wavelength range between 0.8 and 1.2 μm.

4. The method as claimed in claim 19, wherein the irradiation with NIR rays takes place on an open side of the adhesive film before the second substrate to be bonded is placed on.

5. The method as claimed in claim 4, wherein the adhesive film, after the activation with NIR rays and subsequent ending of the radiant exposure, remains adhesive for at least 3 seconds.

6. The method as claimed in claim 19, wherein the second substrate to be bonded is transparent to NIR radiation, and the irradiation of the adhesive film, after the second substrate to be bonded has been placed on, takes place through said substrate.

7. The method as claimed in claim 19, wherein the lamination in the first step takes place at a temperature T_{L} below the lowest activation temperature T_{A,u}.

8. The method as claimed in claim 19, wherein the heat-activatedly bondable adhesive film is one based on a thermoplastic material.

9. The method as claimed in claim 19, wherein the heat-activatedly bondable adhesive film is one based on a hot-crosslinking material.

10. The method as claimed in claim 19, wherein the bonded assembly is subsequently pressed under pressure exposure.

11. The method as claimed in claim 10, wherein the pressing operation takes place within a period after the end of the exposure to NIR radiation in which the adhesive film has not yet fully set.

12. The method as claimed in claim 10, wherein the pressing operation takes place within a period after the end of the exposure to NIR radiation in which the adhesive film is still tacky.

13. The method as claimed in claim 19, wherein at least one of the substrates is transparent or translucent at least in partial regions.

14. The method as claimed in claim 19, wherein at least one of the substrates is selected from the group consisting of components of optical, optoelectronic, electronic, or precision-mechanical devices.

15. The method as claimed in claim 14, wherein the transparent or translucent substrate is a window or a lens for protection of components beneath it and/or for producing physico-optical effects for the function of the optical, optoelectronic, electronic, or precision-mechanical devices.

16. The method as claimed in claim 14, wherein at least one of the substrates is selected from the group consisting of displays.

17. The method as claimed in claim 16, wherein the display is a touch-sensitive screen.

18. The method as claimed in claim 14, wherein the optical, optoelectronic, or electronic device is selected from the group consisting of:
cameras, digital cameras, film cameras, video cameras
small computers (portable computers, pocket computers, calculators), laptops, notebooks, netbooks, ultrabooks, tablet computers, handhelds, electronic appointment calendars and organizers (known as electronic organizers or personal digital assistants, PDAs, palmtops), modems
monitors, displays, screens
reading devices for electronic books (e-books)
small televisions, pocket televisions, film player devices, video player devices
telephones, cordless telephones, cellphones, smartphones, two-way radios, hands-free devices, personal calling devices (pagers, beepers)
GPS devices, navigation devices
wristwatches, digital clocks.

19. A method for adhesively bonding first and second substrates by means of a heat-activatedly bondable adhesive film, said method comprising
in a first step laminating the adhesive film in a heated state onto the first substrate substrates to be bonded;
after said laminating, exposing a side of the adhesive film not in contact with the first substrate to facilitate contact of said side with the second substrate to be bonded; and
bonding the adhesive film with the second substrate;
wherein:
the adhesive film is not pressure-sensitively adhesive at room temperature;
the adhesive film is activated by irradiation with electromagnetic radiation in the near-infrared range (NIR) by heating to a temperature T_{K} above the lowest activation temperature T_{A,u}; and
the bonding with the second substrate to be bonded is brought about by means of the activation by the NIR radiation.
